(19) United States
(12) Patent Application Publication
(10) Pub. No.: US 2026/0349385 A1
(43) Pub. Date: Nov. 5, 2026

(54) Speckle Mitigation

(71) Applicant: Envisics Ltd, Milton Keynes (GB)

(72) Inventor: Daniel Burnham, Milton Keynes (GB)

(21) Appl. No.: 19/197,568

(22) Filed: May 2, 2025

(30) Foreign Application Priority Data
May 6, 2024 (GB) 2406947.8

(51) Int. Cl. G03H 1/22; G03H 1/00

(52) U.S. Cl. CPC G03H 1/2294; G03H 1/0005; G03H 1/2205; G03H 2001/0088; G03H 2001/2297

(57) ABSTRACT

There is provided a holographic projector comprising a display device arranged to form a holographic wavefront by spatially modulating light in accordance with a hologram of a picture displayed thereon. The projector further comprises a kinoform arranged to apply a spiral phase-delay function to at least a sub-area of the holographic wavefront. The spiral phase-delay function comprises a locus corresponding to a minima of the phase-delay function and a phase-delay that is constant with r but continuously changes with θ. r and θ are polar coordinates relative to the locus. Finally, the holographic projector further comprises a movement assembly arranged to move the kinoform. The movement is such that a plurality of different phase-delays are applied to each sub-area of the holographic wavefront within the integration time of the human eye.

### CROSS-REFERENCE TO RELATED APPLICATIONS

This application claims priority under 35 U.S.C. § 119 to UK Patent Application GB 2406947.8 titled “Speckle Mitigation,” filed on May 16, 2025, and currently pending. The entire contents of GB 2406947.8 are incorporated by reference herein for all purposes.

### FIELD

The present disclosure relates to a holographic projector and method of holographic projection. More specifically, the present disclosure relates a holographic projector and method for processing a holographic reconstruction to remove/reduce the perception of speckle. Even more specifically, the present disclosure relates to removing or reducing speckle caused by the interference between pixels of high resolution images by rapidly applying varying phase-delays to pixels of a holographic reconstruction. Some embodiments relate to a holographic projector, picture generating unit or head-up display.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In general terms, there is provided a holographic projector and a method of holographic projection. The hologram that is projected is a hologram of a picture. The holographic projector and projection method are arranged to reduce/minimise the perception of speckle (or speckle-like interference patterns) in a holographic reconstruction of the picture (when viewed by a viewing system).

Holographic projectors typically comprise a coherent light source such as a laser. It is well known that the use of coherent light can lead to unwanted interference patterns being formed. That is, the coherent light might interfere with itself. This can create noise (which is not external noise). In the case of holographic projectors, this noise can degrade the image quality of (virtual) images formed using the holographic projector. One example of this phenomena is referred to as “speckle”.

In other words, “speckle” may be defined as image artefacts caused by the unwanted interaction (e.g. interference) between image pixels of the holographic reconstruction. It is a result of using coherent light to form a high density of image pixels and exists whether the image forms on a real object or not. Another definition is to consider speckle as unwanted structures (e.g. dark and/or bright regions) in the desired light field.

A first source of speckle results from diffuse reflections from (imperfect) surfaces. In particular, imperfections in a reflection surface can create fluctuations/subtle phase changes in different portions of an image—such as a holographic reconstruction—reflected by the surface. These phase changes result in spatially varying constructive and/or destructive interference causing light and dark areas in the projected (virtual) image.

A second source of speckle (or, more accurately, speckle-like noise) arises when the images/holographic reconstructions that are formed by the holographic projector have a relatively high resolution—i.e. relatively high density of image pixels or dots per inch. It is generally desirable for images formed by holographic projectors to be sufficiently high resolution so as to not have the appearance of being pixelated. For an image not to appear pixelated, the points of light/pixels that form that image must be sufficiently close together that they cannot be separated by the eye. However, placing the points of light/image pixels that form the image too close can cause interference between adjacent points/pixels. In particular, cross-talk between light associated with adjacent pixels of the holographic reconstruction causes a speckle-like or grain-like pattern. This interaction/interference may result in a pattern of constructive interference and destructive interference such that there are (unintentional) relatively bright and (unintentional) relatively dark areas in a holographic reconstruction of the picture formed by the holographic projector. This pattern may be considered an image pixel crosstalk. However, this pattern is referred to in this disclosure as speckle-like noise or speckle for shorthand. For example, fine details of the image, such as text, become hard to view/read. In an image formed of red, green and blue light of specific wavelengths, colour variation from the intended colour of the image may be exhibited because of different speckle patterns produced by the red, green and blue light sources. For example, intended uniform white areas of an image may exhibit colour variation and so may not appear uniformly white. Various effects of this nature occur in a real-world system and are broadly referred to herein as speckle or speckle-like even though it may be debatable by academics and the like whether the effects are truly examples of laser-speckle in accordance with the strict definitions accepted in the field. In other words, the term “speckle” is used broadly herein to refer to undesired optical effects that result in the appearance of a grainy or speckly image. The grain or speckle is considered “noise” in the image.

It is known to reduce speckle, or the perception of speckle, by moving the light receiving member/diffuser in holographic projectors that form a holographic reconstruction on such components. For example, the diffuser may be provided as a translating disc. In doing so, the region of the light receiving member that is illuminated with the holographic reconstruction changes over time, thereby changing the pattern of light of the holographic reconstruction that emanates from the light receiving member. This is because statistical imperfections in the light receiving member influence the pattern of speckle so that the pattern changes because a continuously changing set of imperfections is illuminated as the light receiving members moves. As the pattern of speckle changes over time, it is averaged/integrated by the optic system of a human observer, so that the appearance of speckle in the holographic reconstruction is reduced.

However, there are disadvantages to using a moveable light receiving member (e.g. translating disc diffuser) to reduce speckle. In particular, a holographic projector comprising such a moveable diffuser will be arranged to have good image quality in the holographic reconstruction at a single virtual image distance. But, at other distances, the image quality is significantly degraded. It would be desirable to be able to display virtual images at a plurality of arbitrary depths and to be able to display a plurality of virtual images, each at a different (arbitrary) depth, while also achieving good image quality. This is more complex with the “moveable light receiving member” example.

Furthermore, some holographic projectors do not comprise a light receiving member/diffuser. Instead, such holographic projector may be configured such that light that is received by the viewer is spatially modulated in accordance with a hologram (not the picture). For example, a holographic reconstruction of the picture is formed by the eye performing a hologram-to-image transform. In other words, a holographic wavefront is received by the viewing system (eye) rather than an image wavefront. Such holographic projectors may be referred to as “hologram to eye” projectors. Hologram to eye projectors may suffer from at least the second source of speckle identified above. Speckle cannot be reduced by movement of a light receiving member in hologram to eye projectors given the total absence of a light receiving member.

Furthermore, hologram-to-eye projectors cannot use a diffuser because this destroys the coherence of the light and phase information is therefore lost. The holographic display would therefore be limited to single plane display. A component for speckle reduction can be incorporated without destroying the coherency of the holographic wavefront. However, prior speckle reduction components for hologram-to-eye have been imperfect. There is disclosed herein an improved speckle reduction component—particularly for hologram-to-eye projection. Notably, the component does not need to be disposed at the so-called intermediate image plane—e.g. the image plane between two lenses of a 4f optical relay. This is advantageous over prior components, which must be positioned at the intermediate image plane, because the intermediate image may not be planar—e.g. it may occupy a small volume if windscreen compensation or aberration correction has been incorporated into the hologram. A speckle mitigation component disposed at the intermediate image plane may therefore introduce blurriness to the image. Prior devices must therefore make a compromise between speckle appearance and blurriness.

For completeness only, an alternative known method for reducing speckle is to interlace a sparse image. That is, to display e.g. one quarter of the image at any one instance, where the quarter is one pixel within a four pixel diamond. This reduces the possibility of interaction/interference between adjacent pixels and so reduces the possibility of speckle. However, this also reduces the number of pixels of each hologram and can therefore reduce image quality.

For further completeness only, a final alternative known method for reducing speckle is to form many images with independent holograms that have been created from different starting points. Each image has a different speckle pattern, and as all the images are summed by the projector, the speckle ‘averages out’ leading to the desired image. However, the display device has a limited refresh rate and may not be able to display enough independent holograms at the required speed.

The holographic projector and method of holographic projection according to the present disclosure advantageously reduce/minimises speckle (or the perception of a speckle-type effect) and are suitable for forming high quality virtual images at a plurality of (arbitrary) virtual depths. The holographic projector (and method) is particularly advantageous for reducing the second source of speckle (i.e. speckle/grain due to image pixel cross-talk) and doing so in a way that does not require a moving diffuser (and, in fact, does not require a diffuser at all and so is suitable for “hologram to eye” projectors). The absence of a diffuser means that the holographic projector according to the present disclosure may not suffer from the first source of speckle.

In a first aspect, there is provided a holographic projector comprising a display device arranged to form a holographic wavefront by spatially modulating light in accordance with a hologram of a picture displayed thereon. The projector further comprises a kinoform arranged to apply a spiral phase-delay function to at least a sub-area of the holographic wavefront. The spiral phase-delay function comprises a locus corresponding to a minima (or maxima) of the phase-delay function and a phase-delay that is constant with r but continuously changes (e.g. increases or decreases) with θ. In this definition, r and θ are polar coordinates relative to the locus. Finally, the holographic projector further comprises a movement assembly arranged to move the kinoform. The movement is such that a plurality of different phase-delays are applied to each sub-area of the holographic wavefront within the integration time of the human eye.

That is, the phase-delay imparted upon the sub-area (or region/zone) of the holographic wavefront changes (e.g. increases) in a circumferential direction about the locus (or point). When viewing the kinoform in the direction of travel of the holographic wavefront and imagining a straight line with a length r, with one end of the line fixed to the locus, when the line rotates through an angle θ the free end of the line will observe an increased phase-delay. As will be discussed further below, θ need not be a full 360°.

In other words, the kinoform is a spiral phase plate that has an increasing phase retardation as one travels around the sub-area resulting in a phase discontinuity in the beam of light that crosses it.

The appearance of speckle-like noise may be minimised (i.e. speckle reduction may be optimised) when the kinoform is arranged to apply a different phase-delay to adjacent areas of the holographic wavefront in such a way that no two adjacent areas of the holographic wavefront have the same phase-delay applied by moving the kinoform. By creating differing phase-delays across the sub-area, a specific speckle pattern is produced, with the speckle itself being reduced as fewer neighbouring areas of the holographic wavefront have phases that cause the interference observed as speckle. Movement of the kinoform, via the movement assembly, causes the areas of the holographic wavefront to be effected by different regions of the kinoform. This forms a new speckle pattern. As the kinoform is rapidly moved, the human eye “averages” the multiple speckle patterns produced. As the picture is the only constant content received by the eye, the speckle is reduced whilst the picture is observed more clearly.

In other words, the advantage of providing a movement assembly arranged to move a kinoform (arranged to apply a phase-delay to the holographic wavefront such that a different phase-delay is applied to adjacent sub-areas of the holographic wavefront) is to reduce/minimize a speckle effect (or at least the perception of speckle effect). The kinoform (in a first position) is arranged to apply a phase-delay to each sub-area of the holographic wavefront such that the phase-delay applied to each sub-area is different to the phase-delay of an (immediately) adjacent or connecting sub-area. Adjacent sub-areas of the holographic wavefront/points of light interact/interfere with each other to form the speckle pattern. By applying different phase delays to adjacent sub-areas of the wavefront/points of light, the interaction/interference is changed and so the speckle pattern is changed. By moving the kinoform (in particular, moving the kinoform with respect to an optical relay of the holographic projector), different sub-areas of the holographic wavefront interact with different portions of the kinoform and so experience different phase-delays. Importantly, the relative phase-delay between adjacent sub-areas/points of light of the holographic wavefront changes as the kinoform is moved. Each time the relative phase-delay changes, the speckle pattern changes. The kinoform is moved rapidly enough that a plurality of different phase-delays are applied to each sub-area of the holographic wavefront within the integration time of the human eye. So a plurality of different speckle patterns are received by a human observer. The (continuously changing) speckle pattern, is averaged by the optic system of a human observer, so that the appearance of speckle in the image produced from the holographic wavefront is reduced/minimised.

The inventor has devised a phase-delay function for speckle mitigation that is suitable for hologram-to-eye (and therefore hologram-encoded multiplane or even 3D display) and that, notably, does not need to be positioned at an intermediate image plane. The component may be described as comprising a spiral phase-delay function. As described in more detail below, in some embodiments, the centre or loci of the spiral is offset from the geometric centre of the cross-section of the spiral. The inventor has found that this component is effective at speckle reduction when disposed in close proximity (e.g. within 100 mm) to the hologram (or display device). Notably, the component may be disposed before (or upstream) of the hologram—that is, before the holographic wavefront is formed. Equally, the component may be disposed after (or downstream) of the hologram—that is, after the holographic wavefront has been formed. These are significant advantages in a real-world device.

The phase delay caused by the kinoform according to the present disclosure differs from previous kinoforms in that it achieves the speckle reduction by affecting the beam in so-called “Fourier space”—that is, near the hologram. The “Fourier space” (of the hologram) may be within 100 mm of the hologram. The “Fourier space” may be either side of the hologram—that is, before the light is encoded with the hologram or afterwards. In some embodiments, the spiral phase plate forms a Laguerre Gaussian beam. In some embodiments, the spiral phase plate works—at least in part—by changing a component of the direction of the Poynting vector of the light. Whilst a plane wave normally has a Poynting vector parallel to the beam propagation direction, the kinoform of the present disclosure introduces an azimuthal component out of this plane. As the intensity observed is related to the Poynting vector, its alteration changes the intensity.

The kinoform is also independent of the display device, meaning that the light can be modulated using methods that would allow for a higher frequency of refresh rate than usually possible with the display device. Furthermore, the kinoform does not have to be designed with the specifics of the display device in mind or positioned at an intermediate image plane.

Finally, the interlacing of a sparce image is not required to reduce the speckle. This reduces the complexity of the hologram creation, as the sparse pixel images that are interlaced to form the full resolution image (with foci separated to reduce speckle) are not required to be computed. Utilising non-sparse images can allow computational power to be freed up to, for example, allow the holographic projector to display at a higher refresh rate.

The kinoform may be disposed (in other words, arranged) upstream of the display device. Alternatively, the kinoform may be disposed downstream of the display device and the kinoform may be arranged to receive the holographic wavefront. “Upstream” and “downstream” are referred to in terms of the optical path of the light through the projector relative to the hologram/display device. In some embodiments, the holographic projector further comprises an optical relay and the kinoform may be disposed between the display device and the optical relay. That is, the kinoform is not limited by location to the same degree as previous kinoforms for speckle mitigation. The inventor surprisingly found that the kinoform of the present disclosure can be located either before or after the display device and can impart its phase-delays upon the light before or after it has been spatially modulated. This means that the kinoform does not have to be located at an intermediate image plane of the projector (as with the previous despecklers), and so no compromise has to be made between speckle appearance and blurriness in this regard when e.g. windscreen compensation or 3D display is provided.

The change (e.g. increase) in the phase-delay with q may be uniform. That is, the rate of change of the phase-delay is constant throughout the range of θ through which the phase-delay changes e.g. increases. In other words, the rate of change of phase-delay with θ is constant.

The phase-delay change (e.g. increase) applied to each part of the at least one of the sub-area may be in the range of 0 to 2π. The phase-delay change (e.g. increase) applied to at least one of the sub-area may be in the range of 0 to a fraction of 2π. That is, the inventor has found that the speckle reduction effect provided by the kinoform occurs if the phase-delay is over a full wavelength or cycle (i.e. the change in phase-delay from the minima to the maxima is from 0 to 2π), or over a smaller range (for example, from 0 to 1/4π, 1/2π or π).

The phase-delay may change (e.g. increase) with θ in a clockwise circumferential direction, when viewed (or taken) along the direction of travel of the holographic wavefront. The phase-delay may change (e.g. increase) with θ in an anticlockwise circumferential direction, when viewed (or taken) along the direction of travel of the holographic wavefront. The inventor has found that by utilising phase-delay changes (e.g. increases) in differing rotational directions, positive and negative topological charges can be applied to the holographic wavefront to further modify the speckle pattern produced throughout the range of motion of the kinoform.

The locus of at least one of the sub-area may be substantially central to said area. The locus of at least one of the sub-area may be off-centre within said area. That is, the locus may be offset in the x and/or y direction (on the plane of the kinoform) with respect to e.g. the (geometric) centre of said area. The inventor has surprisingly found that the despeckling effect of the kinoform is still observed whether or not the locus is central to the sub-area of the kinoform.

The spiral phase-delay function applied to at least one of the sub-areas may be caused by an increase in thickness of the sub-area of the kinoform in a helical shape, the locus of the sub-area corresponding to a (central) axis of the helical shape. The axis of the helical shape may be parallel to the direction of travel of the holographic wavefront (in other words, the propagation direction of the holographic wavefront or the light spatially modulated by the display device). In other words, the axis of the helix may be parallel to the propagation axis of the holographic wavefront. Optionally, the axis of the helix may be spatially separated from the propagation axis by a so-called “offset”. As the light travels slower through the kinoform than through air, the thicker parts of the sub-area create more of a phase-delay than the thinner parts.

The phase-delay applied to the at least one of the sub-area may change (e.g. increase or decrease) 360° about the locus. That is, θ may be 360°. The phase-delay applied to the at least one of the sub-area may change (e.g. increase or decrease) periodically through equal segments about the locus, optionally wherein each segment is (in other words, has an angular size of) 60°, 72°, 90°, 120°or 180°. That is, θ for each segment may be 60°, 72°, 90°, 120°or 180°.

The kinoform may be within 100 mm of the hologram/display device. The inventor has found that the optical effect of the kinoform may start to break down or otherwise be lost outside of this range. If the kinoform is located optically upstream of the display device, then placing the kinoform close to the display device ensures that the phase-delays applied by the kinoform are retained before the light arrives at the display device. If the kinoform is optically downstream of the display device, placing the kinoform close to the display device ensures that the holographic wavefront has not overly transformed to the image domain (which reduces the ability to apply a phase-delay). Both of these scenarios are to prevent the loss of the effectiveness of the phase-delays in their reduction of speckle appearance. The inventor has identified that the optimum position is within 100 mm of the hologram or within 20x, such as within 10x, of the diameter of the hologram.

The movement assembly may move the kinoform between a first position and a second position on a plane parallel to the display device. In this case, the display device may comprise a plurality of pixels and the movement assembly may move the kinoform at least the pixel pitch of the display device. In other words, the kinoform is moved in translation by the movement assembly. This motion may be linear, rotational, or have an element of both. By moving the kinoform more than the width of one of the pixels of the display device, it is ensured that each across successive time increments multiple speckle patterns are produced (which are then averaged by the human eye, reducing the appearance of speckle, as described above).

The movement assembly may rotate the kinoform about an axis, the axis being distanced from the locus of each spiral phase-delay function. In other words, the axis of rotation (more specifically, the point at which the axis intersects the kinoform) may be offset from the locus of the spiral phase-delay function. As such, the inventor has found that the speckle reduction effect can be produced by both translation and rotation of the kinoform. In some embodiments, each spiral phase-delay function is moved relative to the display device on a plane parallel to the display device.

The movement assembly may move the kinoform at a frequency of 100 Hz or greater, optionally 500 Hz or greater, optionally 1 kHz or greater. In other words, the time period of the movement may be 0.01 s or lower, optionally 2 ms or lower, optionally 1 ms or lower. This inventor has found that this frequency is sufficiently high to allow the human eye to average out the speckle patterns produced, as discussed above. However, it is not so high as to introduce further imperfections into the picture displayed.

The holographic projector may further comprise a plurality of kinoforms arranged to apply a spiral phase-delay function to at least a sub-area of the holographic wavefront. That is, the holographic projector may comprise multiple of the kinoforms described above. Each kinoform further modifies the speckle pattern produced, as described above.

The holographic projector may further comprise an optical relay arranged to receive the holographic wavefront and produce a holographic reconstruction of the picture therefrom referred to herein as an “intermediate image”. The holographic reconstruction may have a number of pixels. The size of the kinoform may be an integer multiple of the pitch of the pixels. In some embodiments, there are at least twice as many pixels of the holographic reconstruction as there are spiral phase-delay functions applied by the kinoform. In some embodiments, there are at least twice as many spiral phase-delay functions applied by the kinoform as there are pixels of the holographic reconstruction.

In some embodiments, a single hologram forms the holographic reconstruction of the picture. In some embodiments, multiple holograms collectively form the holographic reconstruction of the picture (i.e. a “tiled” hologram). The inventors has found that the kinoform of the present disclosure works with both formulations.

In a second aspect, there is provided a method of holographic projection. The method comprises a first step of displaying a hologram of a picture. Subsequently, the method comprises a step of spatially modulating light in accordance with the hologram to form a holographic wavefront. A spiral phase-delay function is applied to at least a sub-area of the holographic wavefront. The spiral phase-delay function comprises a locus corresponding to a minima (or maxima) of the phase-delay function and a phase-delay that is constant with r but continuously changes (e.g. increases or decreases) with θ. r and θ are polar coordinates relative to the locus. The kinoform is moved such that each pixel of the holographic reconstruction has a plurality of different phase-delays applied thereto within the integration time of the human eye.

Feature and advantages described in relation to the first aspect may apply to the method of the second aspect, and vice versa.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure Is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6A shows an idealised view of a portion of image pixels of a first image in the form of a uniform array of pixels, the idealised view being absent of interference effects between pixels;

FIG. 6B shows an idealised view of a portion of image pixels of a second image in the form of a uniform array of pixels, the spacing between the pixels of the second image being less than the spacing between the pixels of the first image, and the idealised view being absent of interference effects between pixels;

FIG. 6C shows the portion of the first image of FIG. 6A in reality (including interference effects between pixels);

FIG. 6D shows the portion of the second image of FIG. 6B in reality (including interference effects between pixels) and how the relatively smaller pixel spacing in FIG. 6D results in significant deviation from the ideal case as a result of speckle;

FIG. 7A shows representations of the light field associated with individual pixels of the image of FIG. 6A/6C;

FIG. 7B shows representations of the light field associated with individual pixels of the image of FIG. 6B/6D;

FIG. 8 shows a schematic cross-sectional view showing features of a holographic projector according to a first embodiment of the present disclosure;

FIG. 9 shows a schematic cross-sectional view showing features of a holographic projector according to a second embodiment of the present disclosure;

FIG. 10 shows a spiral phase plate according to the present disclosure;

FIG. 11 shows a schematic top view of a first spiral phase plate according to the present disclosure;

FIG. 12 shows a schematic top view of a second spiral phase plate according to the present disclosure;

FIG. 13 shows a schematic representation of the spiralising effect of a spiral phase plate according to the present disclosure;

FIG. 14 shows the effect a spiral phase plate according to the present disclosure has on a plane wave;

FIG. 15 shows an example of a spiral phase wavefront caused by a spiral phase plate according to the present disclosure;

FIG. 16 shows the speckle contrast of a holographic projector according to the prior art as compared to the speckle contrast of a holographic projector according to the present disclosure; and

FIG. 17 shows a schematic representation of a method of speckle reduction according to a further aspect of the present disclosure.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

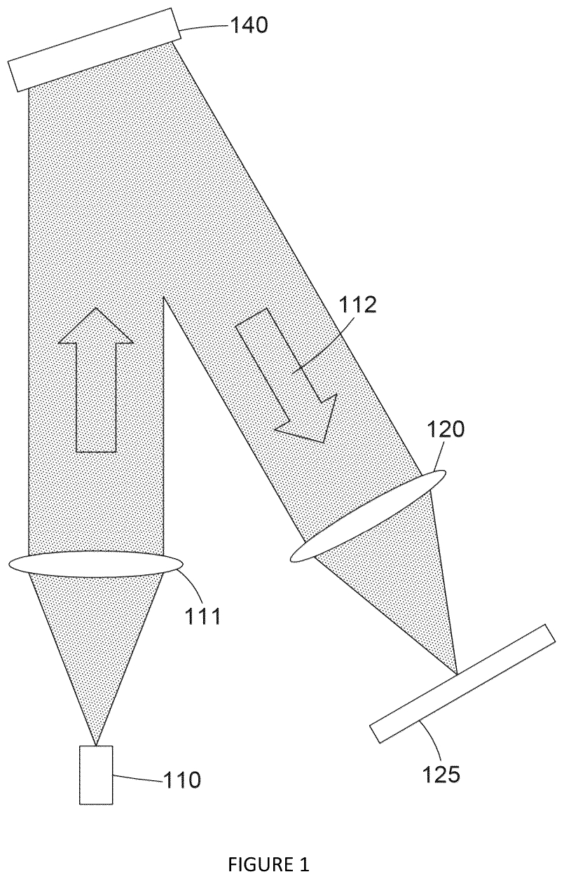

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Eye-box Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays That are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be Less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

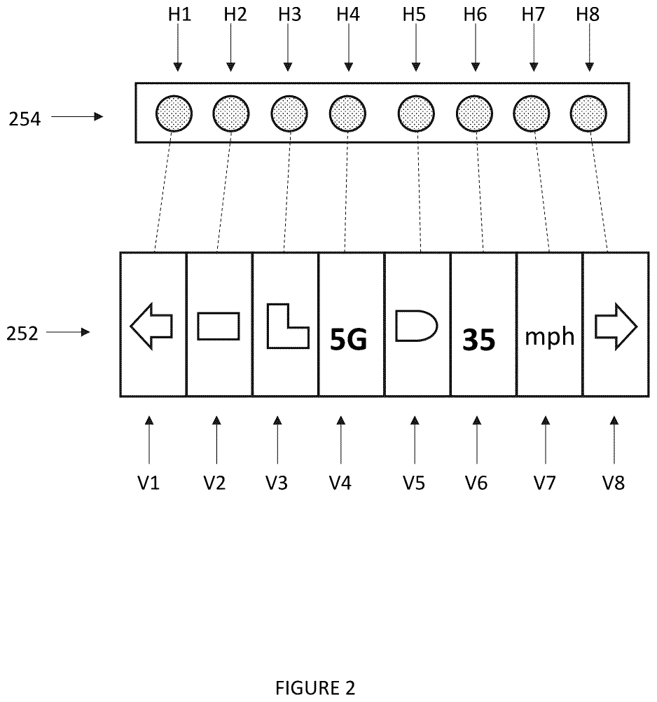

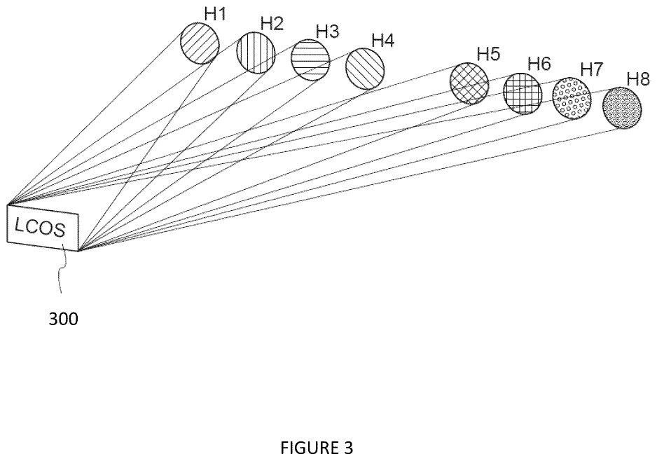

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

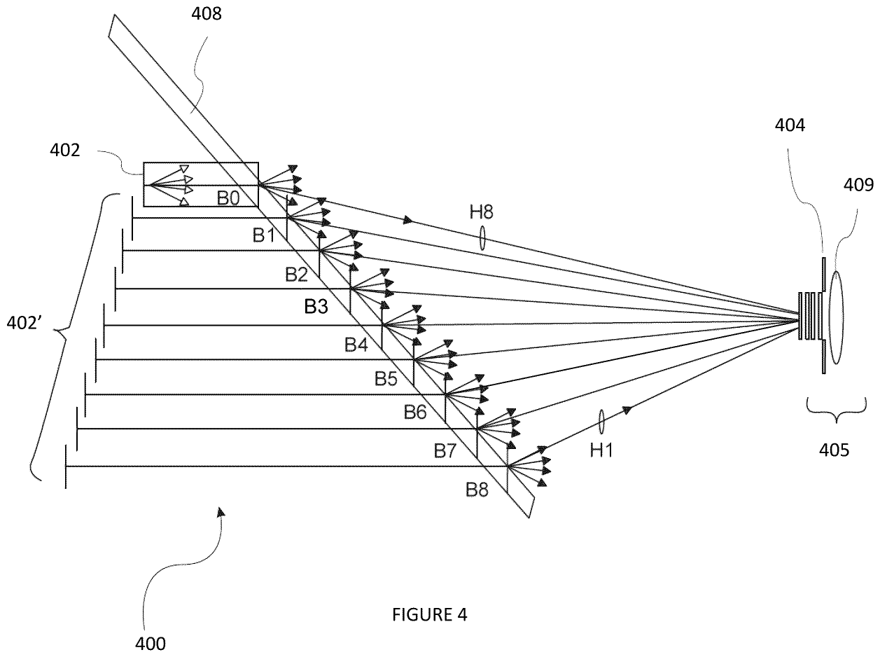

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

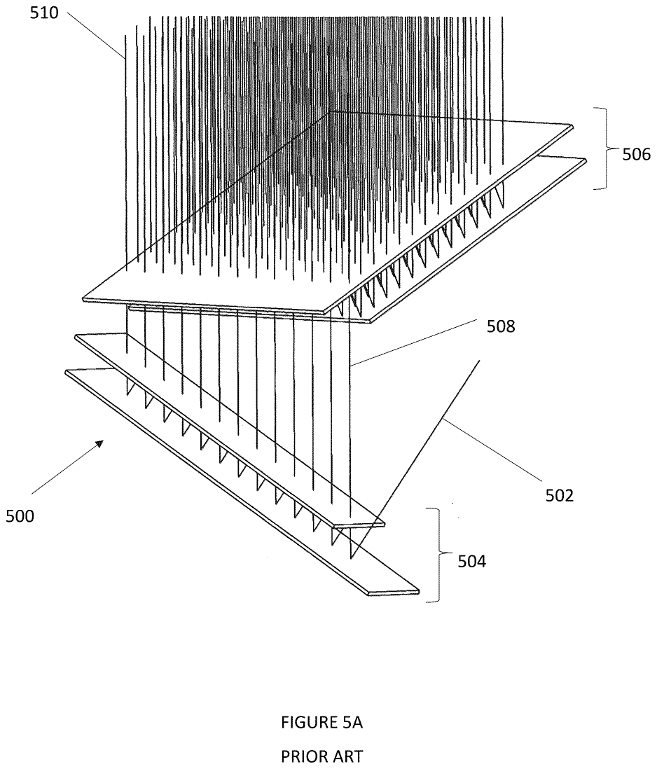

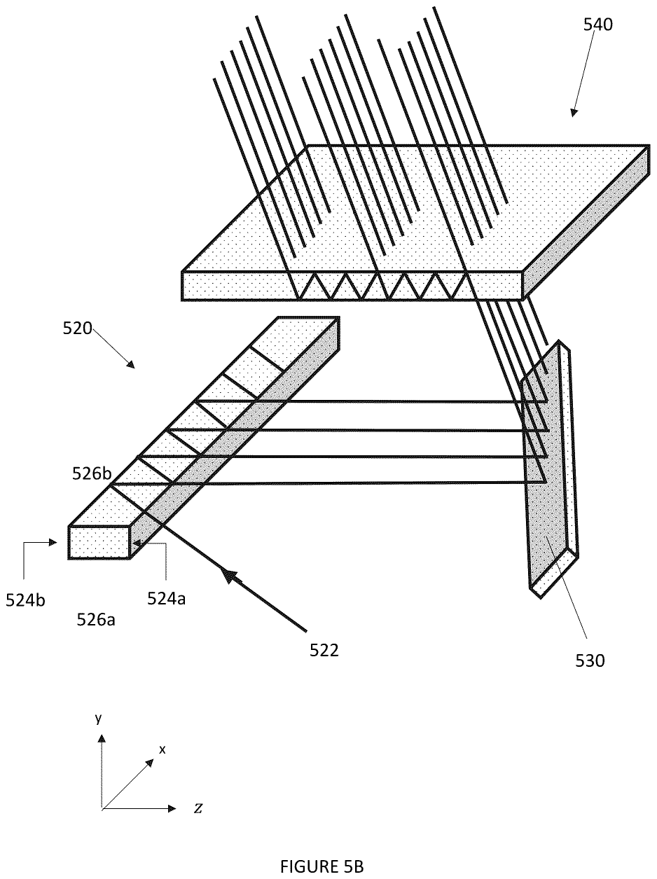

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication- or, pupil expansion-in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)-which, in practice, means a small display device (e.g. 1 cm). This addresses the problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LcoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The converging or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2,936,252 incorporated herein by reference). The present disclosure is compatible with holograms that compensate for the complex curvature of an optical combiner used as part of the projection system. In some embodiments, the optical combiner is the windscreen of a vehicle. Full details of this approach are provided in European U.S. patent 2,936,252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Speckle in High-resolution Images

It has been described how a (holographic) projector is arranged to relay light from a display device (SLM) to a viewing system (such as a the eye of a user) at an eye-box. The lens of the eye performs a hologram-to-image transformation such that the viewer receives an image. This image is pixelated. That is, the holographic reconstruction comprises image spots or pixels. It is generally desirable for the image to have a high enough resolution that the user cannot perceive the individual pixels. While such a resolution may be high enough to remove the perception of the individual pixels, another problem is introduced. In particular, light associated with adjacent (close together) pixels will interact (interfere) creating a pattern of dark and light areas which degrades the quality of the image. Throughout this disclosure, this effect is referred to as speckle. This is described in more detail below.

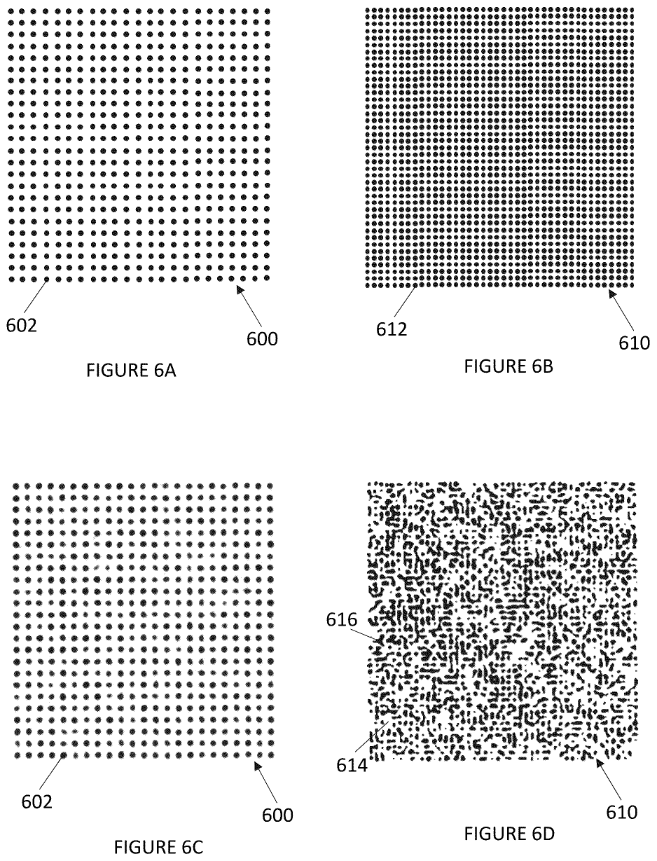

FIGS. 6A to 6D show how the speckle effect increases as the resolution of an image increases. For simplicity, amplitude information is omitted from each of FIGS. 6A to 6D.

FIGS. 6A and 6B represent how the pixels of a portion of an image (or holographic reconstruction) would ideally appear in the absence of speckle (specifically, in the absence of interference effect between pixels). FIG. 6A corresponds to a portion 600 of a first image having a relatively low resolution. FIG. 6B show a portion 610 of a second image having a relatively high resolution. Thus, the individual pixels 602 of FIG. 6A are further apart than the individual pixels 612 of FIG. 6B. In the idealised case of FIGS. 6A and 6B, the image pixels of both the first and second images form a uniform array.

FIGS. 6C and 6D represent how the pixels of the portions 602,610 of the images (or holographic reconstructions) appear in reality (including the speckle effect). FIG. 6C shows the portion 600 of the first image but with the speckle effect. FIG. 6D shows the portion 610 of the second image but with the speckle effect.

Because the pixels of the first image (of FIGS. 6A and 6C) have a relatively large spacing, any interference between light of adjacent pixels is minimal. As such, the speckle effect in FIG. 6C is substantially negligible and the pixels maintain their appearance of being in a uniform array. However, the image is unacceptably poor given its low resolution (and so pixelated) nature.

Because the pixels of the second image (of FIGS. 6B and 6D) have a relatively small spacing, the interference between light of adjacent image pixels in the second image is much more significant than in the first image. As such, the speckle effect in FIG. 6D is not substantially negligible. In particular, interference between light associated with pixels of the second image results in dark areas 614 and light areas 616 being formed (which are not present in the idealised case of FIG. 6B). So, as a result of the speckle effect, the image of FIG. 6D does not appear as a uniform points of light but rather is granulated and noisy. So, although the resolution in the second image may be acceptably high so as to, in theory, not appear pixelated, the speckle-effect significantly degrades the quality of the image that is actually perceived.

So, in summary, without speckle mitigation, image quality may either be poor as a result of being too low resolution and appearing pixelated or (at higher resolutions) noisy and so poor because of the speckle-effect.

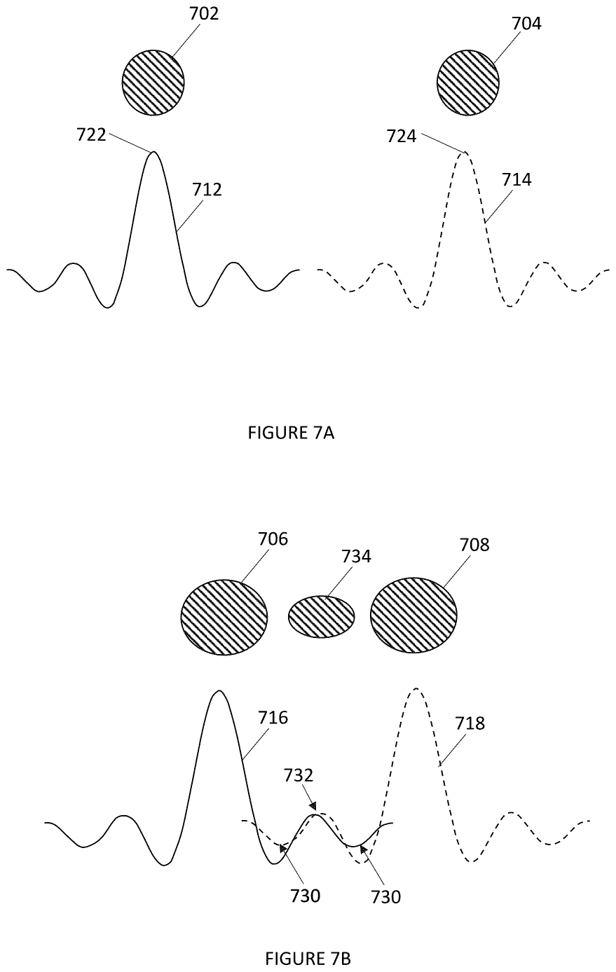

The causes of the speckle shown in FIG. 6D are explained in more detail with reference to FIGS. 7A and 7B. FIGS. 7A and 7B each show representations of the light field associated with individual pixels as well as an intensity profile of the image pixel (which has the form of a sinc squared function). FIG. 7A show representations of the light field associated with individual pixels of the first image (of FIG. 6A/6C). FIG. 7B show representations of the light field associated with individual pixels of the second image (of FIG. 6B/6D).

FIG. 7A represents two adjacent pixels 702, 704 of the first image (of FIG. 6A/6C) and FIG. 7B represents two adjacent pixels 706,708 of the second image (of FIG. 6B/6D). The light associated with each pixel 702 to 708 takes the form of a sinc squared function, also shown in FIGS. 7A and 7B. A first sinc squared function 712 is associated with pixel 702, a second sinc squared function 714 is associated with pixel 704, a third sinc squared function 716 is associated with pixel 706 and a fourth sinc squared function 718 is associated with pixel 708. Only the first and second so-called side-lobes of each sinc squared function (either side of the respective main lobe) are shown in FIGS. 7A and 7B.

As discussed in relation to FIGS. 6A and 6C, the pixels in the first image have a relatively large spacing compared to the pixels of FIGS. 6B and 6D. As such, the two adjacent pixels 702,704 of the first image (shown in FIG. 7A) are further apart than the two adjacent pixels 706,708 (shown in FIG. 7B) of the second image. Each pixel 704 to 708 has an intensity which varies in space substantially in the shape of a sinc squared function. The appearance of the pixels (which are ideally circular) may be affected by interference of the sinc squared functions. In particular, the perceived intensity pattern at any point in space will depend on the sum of the interactions/sum of the value of the sinc squared functions of all the pixels at that respective point in space. For simplicity, two pixels and the respective sinc squared functions are shown in FIGS. 7A and 7B.

The spacing between pixels 702,704 is relatively large, so there is no significant overlap between first and second respective sinc squared functions 712,714, associated with these pixels. Of course, some higher-order side-lobes (not shown in FIGS. 7A and 7B) may interact. But the amplitude of the higher-order side-lobes is so small as to be negligible and so the interference caused by the interaction of the higher-order side-lobes is also negligible. As a result, the main lobes 722,724 of the first and second sinc squared functions 712,714 substantially contribute to substantially circular and spatially separated points of light (pixels 702,704). The situation is different when the pixels are closer together.

The spacing between pixels 706,708 is relatively small, so there is a significant overlap between the third and fourth sinc squared functions 716,718 associated with these pixels. As can be seen in FIG. 7B, the lobes of the third and fourth sinc squared functions 716,718 are overlapping. In particular, there is some overlap of the second order side-lobes of the third sinc squared function 716 with the main lobe of the fourth sinc squared function 718 (and vice versa). Similarly, the first and second order side-lobes of the third sinc squared function 716 overlap with the first and second order side-lobes of the fourth since function 718. This overlapping resulting in areas of constructive interference and areas of destructive interference. For example, the interaction between the main lobe of each sinc squared function with a second order side lobe of the other sinc squared function is constructive. This constructive interference results in the pixels 706,708 appearing elongated/oval rather than round. The interaction between the side lobes of each sinc squared function (between the main lobes) has two destructive regions 730 and one constructive region 732. The constructive region 732 results in an additional (unintentional) point of light 734 between the pixels 706,708.

For simplicity, FIG. 7B merely shows the interaction of the sinc squared function of two pixels (pixels 706,708). In reality, an image is formed by an array of pixels, with the sinc squared functions of each pixel interacting with at least several other nearby pixels. For example, each pixel may have four adjacent pixels, the light of which each of which may significantly interact/interfere with light of that respective pixel. Thus, the resulting interference pattern is much more complex than that shown in FIGS. 7A and 7B (e.g. see the complex pattern formed in FIG. 6D as a result of speckle/interference0. However, it should be clear from the two pixels shown in FIG. 7B how the interference effect of relatively close pixels can degrade image quality. For example, FIG. 7B shows both the effect of the elongation of pixels 706,708 and the introduction of an unintentional bright region between the pixels substantially reduces image quality. In addition, unintentional dark regions may also be created.

The interference described in relation to FIG. 7B and the corresponding reduction in the quality of resulting images is referred to in this disclosure as speckle.

### Improved Speckle Reduction

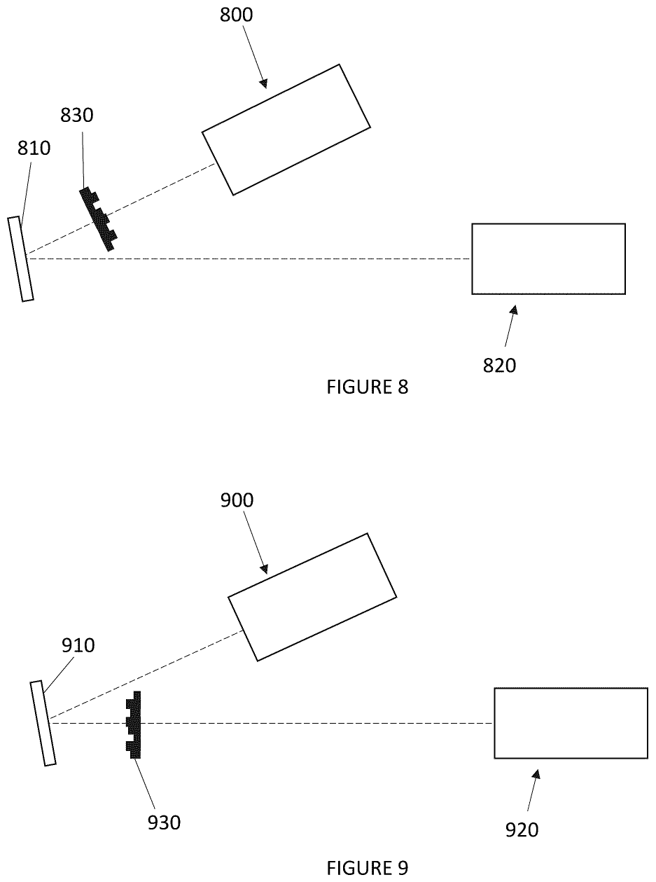

FIG. 8 is a schematic cross-sectional view showing features of a holographic projector according to a first embodiment of the present disclosure. These features are arranged in order to minimise/reduce speckle in the images formed by the holographic projector. In particular, FIG. 8 shows a spatial light modulator 810 (which, in some examples, is a liquid crystal on silicon pixelated spatial light modulator) and an optical relay 820. The spatial light modulator 810 is illuminated by light source 800 (as discussed above in relation to FIG. 1) to form a holographic wavefront. That is, during operation of the holographic projector, a hologram of a picture is displayed on the spatial light modulator 810. Light is emitted from the light source 800, which is a coherent light source (e.g. a laser) of the holographic projector, the light being incident the spatial light modulator 810. The light is spatially modulated in accordance with the hologram displayed on the spatial light modulator 810 to form a holographic wavefront. The optical relay 820 acts as a magnifying telescope and relays the light (either as a holographic wavefront, or having been transformed to the image domain by the optical relay 820) to the waveguides for pupil expansion as discussed above. A kinoform 830 (which could also be described as a diffractive optical element) is disposed between the light source 800 and the spatial light modulator 810. It should be noted that the kinoform 830 does not need to arranged at a focal point of the holographic projector, unlike in previous systems.

The holographic projector further comprises a movement assembly arranged to move the kinoform 830. As will explained in more detail below, the position and arrangement of kinoform 830 are such that rapid movement of the kinoform 830 with respect to the spatial light modulator 810 (e.g. with respect to the optical axis of the light from the light source 800) substantially reduces speckle.

This is achieved as light from the light source 800 interacts with the kinoform 830. The kinoform 830 applies a phase-delay to the light that forms the holographic wavefront. In particular, the kinoform 830 is arranged such that, after the light is spatially modulated by the spatial modulator 810, a phase delay applied to each pixel of a holographic reconstruction or image formed by the holographic wavefront is different to the phase-delay applied to each pixel that is adjacent to the respective pixel.

The kinoform 830 comprises an array of discrete regions (in other words, sub-areas or zones). In this example, the array is multiple regions, however an embodiment is envisaged wherein the kinoform 830 comprises a single region. Each region of the kinoform 830 is arranged to apply a range of phase-delays, also known as a spiral phase-delay function, as will be described in greater detail below.

Rapidly moving the kinoform between the first and second positions results in a plurality of different speckle patterns being formed at the viewing system. By moving the kinoform at a sufficiently high frequency between the first and second position, this changing speckle pattern is averaged by the optic system of a human observer (because a plurality of different phase-delay values are applied and associated speckle patterns form within the integration time of the human eye). The result is that the appearance of speckle in the holographic reconstruction is reduced.

In the example above, the kinoform 830 is moved translationally between the first position and the second position. The translational movement is on a plane orthogonal to the direction of travel of the wavefront from the light source 800, however movement along this direction of travel may be present. Alternatively, the kinoform 830 can be rotated about an axis of the light beam from the light source 830, provided that (if rotation is utilised) the region (or regions) of the kinoform 830 are off-centre from the axis of rotation. That is, the inventor has discovered that the speckle reduction effect will be observed as long as the regions are moved translationally with respect to the plane of the spatial light modulator 810. This is because the movement causes a series of different speckle patterns to be produced over time (due to the changing phase-delays). These speckle patterns are then “averaged out” by the eye of the viewer, reducing the appearance of speckle.

In some embodiments, the movement is such that each region moves at least the length (or width) of a pixel of the spatial light modulator 810. This ensures that the light being received at each pixel has a different phase-delay in successive time increments. In some embodiments, the movement of the kinoform 830 is less than the length (or the width) of the spatial light modulator 810. In this way, no unnecessary movement is made (i.e. movement to positions in which no phase-delay is provided by the kinoform 830).

Furthermore, in the example above, the kinoform is transmissive, with light of the holographic reconstruction being transmitted through the kinoform. In other examples, the kinoform may be reflective. For example, the kinoform may comprise a reflective coating on e.g. a back surface arranged to reflect light from the light source 800.

FIG. 9 is a schematic cross-sectional view showing features of a holographic projector according to a second embodiment of the present disclosure. In this embodiment, the light source 900, spatial light modulator 910, optical relay 820 and kinoform 930 are the same as described above in relation to the first embodiment of FIG. 8. However, the inventor has surprisingly found that the speckle reduction is equally observed when the kinoform 930 is downstream of the hologram e.g. located between the spatial light modulator 910 and the optical relay 920. As with the first embodiment, and unlike in previous systems, the kinoform 930 does not need to be positioned at an intermediate image plane of the holographic projector.

FIGS. 8 and 9 are schematic and as such are not necessarily to scale. The inventor has found that the kinoform 830, 930 must be located within a sufficiently close distance to the spatial light modulator 810, 910 such that the optical effect provided by the kinoform 830, 930 does not break down or is otherwise lost. In the embodiment of FIG. 8, if the distance between the kinoform 830 and spatial light modulator 810 is too great, then the varying phase-delays applied by the kinoform 830 may begin to normalise, thus reducing their effect on speckle reduction. Likewise, in the embodiment of FIG. 9, if the distance between the spatial light modulator 910 and kinoform 930 is too great, then the holographic wavefront (which is in the Fourier domain) will begin to return to the image domain and as such the phase-delays applied by the kinoform 930 will not affect the entirety of the wavefront (and thus the speckle reduction effect will be reduced). In one example, a distance that prevents this loss of speckle reduction effect is within 100 mm, although other distances are envisaged.

FIG. 10 shows an example of a region 1000 of the kinoforms 830, 930. The top face 1010 of the region 1000 has a helical shape, with a lower part 1020 of the top face 1010 rising to a higher part 1030 over a rotation θ, as will be further described below. It should be noted that, although the cut away shown in FIG. 10 has a square area, the phase-delay is applied over a circular shape, as will also be further described below. The rotation θ occurs about a locus or point 1040.

In this example, the amount of phase-delay applied by the regions of the kinoform 830, 930 varies across each region as it is dependent on the thickness of the part of the region that the light passes through. In such embodiments, the kinoform 830, 930 comprises a transparent material such as glass or quartz having a refractive index greater than 1. Thus, light propagates more slowly through the kinoform 830, 930 than through air and so the phase-delay applied to light will increase with increasing thickness. Therefore, as the thickness of the region 1000 increases throughout the rotation θ, so will the phase-delay imparted upon the light.

As such, the phase-delay is at its lowest when the light is exiting the region of the kinoform 830, 930 from the lower part 1020. Then, when travelling through rotation θ, the phase-delay of the light exiting the region of the kinoform 830, 930 increases until it reaches a maximum at the higher part 1030, due to the increase in thickness from the helical shape.

As is discussed below, the phase delay may be from 0 to 2π, in which case the “drop off” in thickness from the higher part 1030 to the lower part 1020 has no change in phase-delay (as 0=2π with regards to phase-delays). As such, the phase-delay imparted by the region can be thought of as continuously increasing through full rotations θ. This imparts a spiral wave form, as will be discussed in greater detail below.

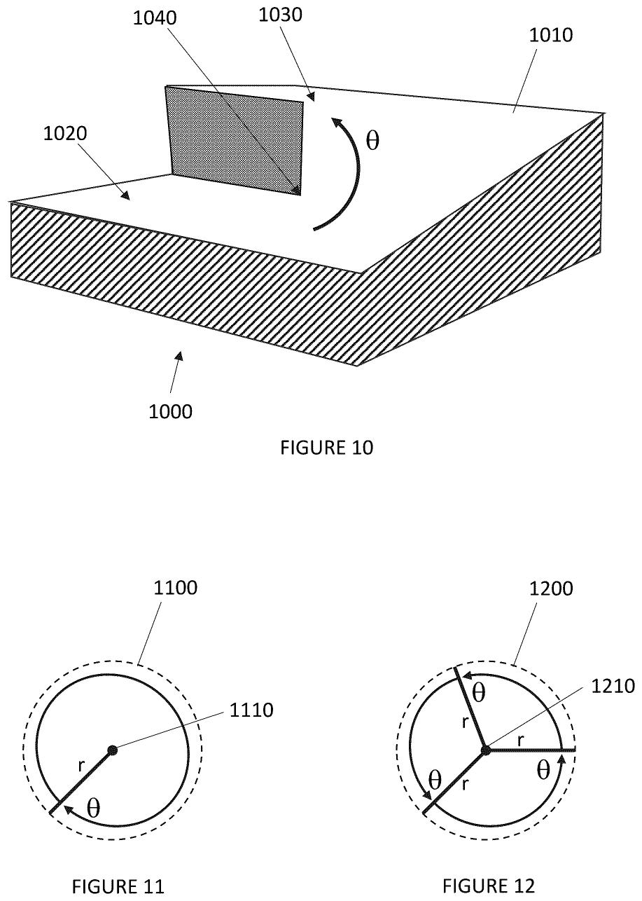

FIGS. 11 and 12 show schematic top views of two examples of regions of the kinoform 830, 930. Each region applies a varied phase-delay over a circular area 1100, 1200. The phase-delay varies around a central point 1110, 1210 with angle θ. Along the radius r of the area 1100, 1200, the phase-delay applied is the same at any angle θ. In the above-described embodiment of FIG. 10, the phase-delay increase is caused by an increase in thickness about the central point 1110, 1210 with θ. In other words, along the radius r of the area 1100, 1200, the thickness is the same at any angle θ.

In the embodiment of FIG. 11, the increase in phase-delay with θ is through a full 360°. Meanwhile, in the embodiment of FIG. 12, there are three consecutive phase-delay increases throughout a rotation θ of 360°, forming three even sectors and therefore three phase discontinuities. Other phase-delay increases with θ are envisaged. The phase-delay increase with θ may be from 0 to 2π. However, the phase-delay increase may also be from 0 to a fraction of 2π. In the embodiment of FIG. 11, the phase-delay increase is in a clockwise direction, whereas said increase is in an anticlockwise direction in the embodiment of FIG. 12. That is, the embodiments of FIGS. 11 and 12 have positive and negative topological charges compared to one another. If there are a multiple of such regions on the kinoform 830, 930, they may all be the same, or they may be different to further modify the phase discontinuity of the holographic wavefront.

In some embodiments, the optical relay 820, 920 transforms the holographic wavefront into a holographic reconstruction-that is, there is a formed an intermediate image. In such examples where there are multiple regions (e.g. angular sectors) on the kinoform 830, 930, there are embodiments wherein the regions are such that there are at least twice the number of pixels in the holographic reconstruction as there are regions.

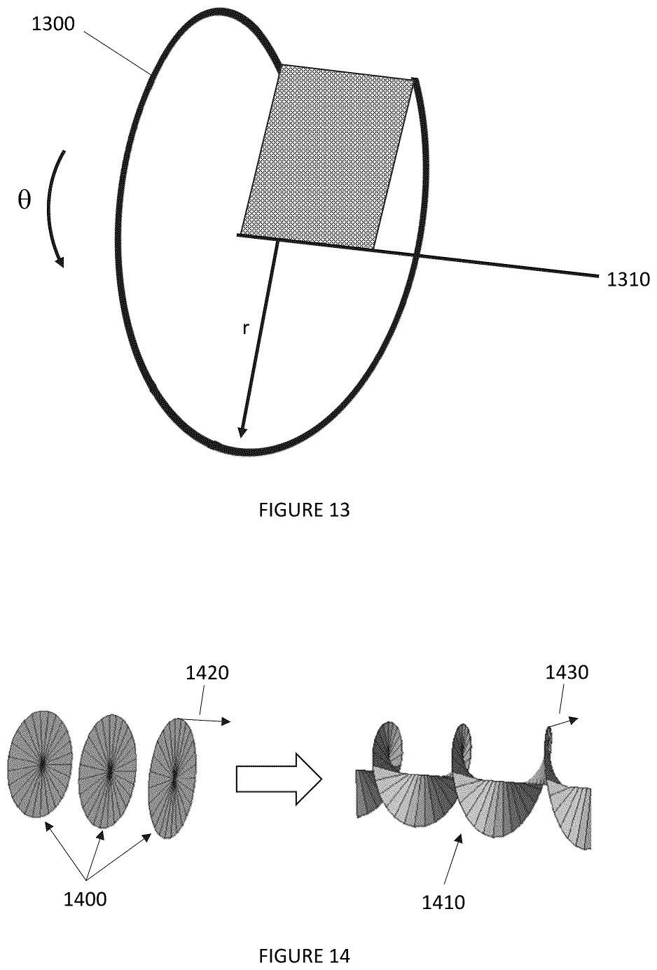

FIG. 13 shows a schematic representation of the spiralising effect the regions described above has on a plane (or planar) wave. The result of this effect is then shown in FIG. 14. As described above, a spiral pattern 1300 is produced with θ, about a point or locus 1310. A plane wave 1400 interacts with the kinoform 830, 930, imparting the spiralised pattern described above, resulting in the spiral wavefront 1410. In some embodiments, the kinoform introduces a plurality of phase discontinuities, further reducing the appearance of speckle as the kinoform 830, 930 is moved.

The spiral wavefront 1410 is also a Laguerre Gaussian beam, due to the interaction and interference of the light in the area of the locus or point about which the phase-delay increase rotates. That is, the light waves in and about the locus or central point 1110, 1210 of the region interferes with itself such that are dark spot appears around the locus or central point 1110, 1210. The phase-delay imparted by the region (or regions) also modifies the Poynting vectors of the wavefront. Before interacting with the kinoform 830, 930, the plane wavefront 1400 has Poynting vectors 1420 parallel to the direction of travel of the wavefront. However, the interaction with the region (or regions) adds an azimuthal component to the Poynting vectors 1430 of the spiral wavefront 1410, such that they are not parallel to the direction of travel of the wavefront.

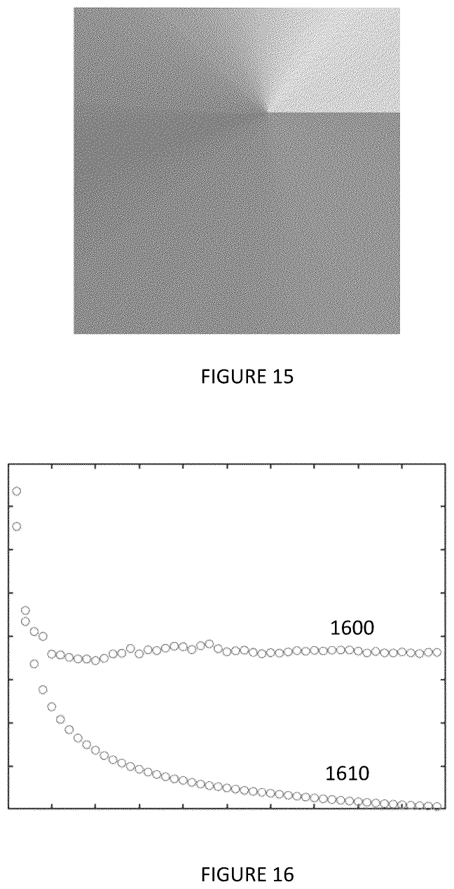

FIG. 15 shows an example of a holographic wavefront with a varying phase-delay applied by one of the regions of the kinoform 830, 930 as described above. The darker portions of the image represent no phase-delay (or a phase delay of 0), whilst the lighter portions of the image represent a phase-delay of 2π.

FIG. 16 shows a graph comparing the speckle contrast of a holographic reconstruction of the prior art against a holographic reconstruction according the present disclosure. Speckle contrast increases on the Y-axis, whilst the number of positions the kinoform 830, 930 is moved to increases on the X-axis. As can be seen, the prior art 1600 shows a higher speckle contrast (and thus more visible speckle) than the present disclosure 1610.

### Alternative Speckle Reduction Method

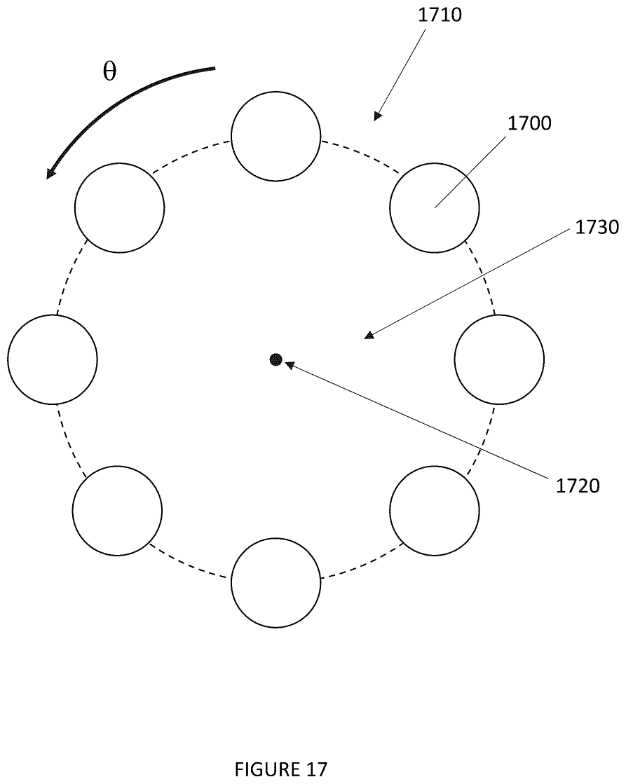

An alternative method of reducing the appearance of speckle is schematically shown in FIG. 17. The inventor has observed that, by interfering two out of phase Laguerre Gaussian beams (that is, two beams with different phases), the “flower” pattern shown in FIG. 17 is produced. Bright areas 1700 (the “petals”) alternate with dark areas 1710 in a circular pattern. The circular pattern is arranged around (or about) a central point 1720 with a central dark area 1730.

The central dark area 1730 arises in Laguerre Gaussian beams (as described above), whilst the alternating bright and dark areas 1700, 1710 are produced by interference of light waves within the beams due to their difference in phase. The inventor has discovered that, by altering the relative phases of the two beams, the “flower” pattern rotates though θ about central point 1720. That is, by altering the difference in phases between the two interfering beams, the bright areas 1700 appear to rotate about central point 1720. Although FIG. 17 shows the rotation θ being in an anticlockwise direction, a clockwise direction can also be achieved using this method. Similarly, features of the pattern, such as the number and/or spacing of the “petals” (the bright areas 1700) may be different from those shown in FIG. 17, which is given as an example.

By using this rotating pattern to illuminate the spatial light modulator 810, 910 (that is, by using the two interfering beams creating this rotating pattern as the light source 800, 900), a different speckle pattern can be produced over time. Multiple of these rotating patterns can also be used simultaneously. At any given time increment, the spatial light modulator 810, 910 will be illuminated differently. As such, at any given time increment a different speckle pattern will be produced. As described above, these speckle patterns are then “averaged out” by the eye of the viewer, reducing the appearance of speckle. In essence, the rotation of this pattern acts as the movement of the kinoform 830, 930 in the above described embodiments.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A holographic projector comprising:
a display device arranged to form a holographic wavefront by spatially modulating light in accordance with a hologram of a picture displayed thereon;
a kinoform arranged to apply a spiral phase-delay function to at least one sub-area of the holographic wavefront, wherein the spiral phase-delay function comprises a locus corresponding to a minima of the spiral phase-delay function and a phase-delay that is constant with r but continuously changes with θ, and wherein r and θ are polar coordinates relative to the locus; and
a movement assembly arranged to move the kinoform such that a plurality of different phase-delays are applied to each sub-area of the holographic wavefront within an integration time of a human eye.

2. The holographic projector of claim 1, wherein the kinoform is disposed upstream of the display device.

3. The holographic projector of claim 1, wherein the kinoform is disposed downstream of the display device and the kinoform is arranged to receive the holographic wavefront.

4. The holographic projector of claim 3, further comprising an optical relay and wherein the kinoform is disposed between the display device and the optical relay.

5. The holographic projector of claim 1, wherein a change in the phase-delay with q is uniform.

6. The holographic projector of claim 1, wherein a phase-delay change applied to each part of the at least one sub-area is in a range of 0 to 2π.

7. The holographic projector of claim 1, wherein a phase-delay change applied to each part of the at least one sub-area is in a range of 0 to a fraction of 2π.

8. The holographic projector of claim 1, wherein a phase-delay change with q is in a clockwise circumferential direction when viewed along a direction of travel of the holographic wavefront.

9. The holographic projector of claim 1, wherein a phase-delay change with q is in an anticlockwise circumferential direction when viewed along a direction of travel of the holographic wavefront.

10. The holographic projector of claim 1, wherein the locus of the at least one sub-area is substantially central to the at least one sub-area.

11. The holographic projector of claim 1, wherein the locus of the at least one sub-area is off-centre within the at least one sub-area.

12. The holographic projector of claim 1, wherein the spiral phase-delay function applied to the at least one sub-area is caused by an increase in thickness of the at least one sub-area of the kinoform in a helical shape, and wherein the locus of the at least one sub-area corresponds to an axis of the helical shape.

13. The holographic projector of claim 12, wherein the axis of the helical shape is parallel to a direction of travel of the holographic wavefront.

14. The holographic projector of claim 1, wherein the phase-delay applied to the at least one sub-area changes 360° about the locus.

15. The holographic projector of claim 1, wherein the phase-delay applied to the at least one sub-area changes periodically through equal segments about the locus, optionally wherein each segment is 60°, 72°, 90°, 120°or 180°.

16. The holographic projector of claim 1, wherein the kinoform is within 100 mm of the display device.

17. The holographic projector of claim 1, wherein the movement assembly moves the kinoform between a first position and a second position on a plane parallel to the display device.

18. The holographic projector of claim 17, wherein the display device comprises a plurality of pixels and the movement assembly moves the kinoform at least a pixel pitch of the display device.

19. The holographic projector of claim 1, wherein the movement assembly rotates the kinoform about an axis, and wherein the axis is distanced from the locus of each spiral phase-delay function.

20. The holographic projector of claim 1, wherein the movement assembly moves the kinoform at a frequency of at least one of (i) 100 Hz or greater, (ii) 500 Hz or greater, or (iii) 1 kHz or greater.

21. The holographic projector of claim 1, further comprising a plurality of kinoforms arranged to apply a spiral phase-delay function to at least a sub-area of the holographic wavefront.

22. The holographic projector of claim 1, further comprising an optical relay arranged to receive the holographic wavefront and produce a holographic reconstruction of the picture therefrom, wherein the holographic reconstruction has a number of pixels, and wherein a size of the kinoform is an integer multiple of a pitch of the pixels.

23. A method of holographic projection, the method comprising:
displaying a hologram of a picture; and
spatially modulating light in accordance with the hologram to form a holographic wavefront via a kinoform, wherein a spiral phase-delay function is applied to at least one sub-area of the holographic wavefront, wherein the spiral phase-delay function comprises a locus corresponding to a minima of the spiral phase-delay function and a phase-delay that is constant with r but continuously changes with θ, and wherein r and θ are polar coordinates relative to the locus; and
wherein the kinoform is moved such that each pixel of a holographic reconstruction of the picture has a plurality of different phase-delays applied thereto within an integration time of a human eye.
